(19) United States
(12) Patent Application Publication
(10) Pub. No.: US 2013/0069466 A1
(43) Pub. Date: Mar. 21, 2013

(54) SPINDLE MOTOR

(71) Applicants: Ho Jun Yoo, Gyunggi-do (KR); Yeol Choi, Gyunggi-do (KR); Young Sun Yoo, Gyunggi-do (KR)

(72) Inventors: Ho Jun Yoo, Gyunggi-do (KR); Yeol Choi, Gyunggi-do (KR); Young Sun Yoo, Gyunggi-do (KR)

(73) Assignee: SAMSUNG ELECTRO-MECHANICS CO., LTD., Gyunggi-do (KR)

(21) Appl. No.: 13/325,027

(22) Filed: Dec. 13, 2011

(30) Foreign Application Priority Data
Sep. 16, 2011 (KR) 1020110093601

(51) Int. Cl. H02K 7/09

(52) U.S. Cl. 310/90.5

(57) ABSTRACT

Disclosed herein is a spindle motor including: a shaft; a bearing receiving the shaft therein to thereby rotatably support the shaft; a bearing holder having the bearing mounted therein; an armature including a core stacked on an outer diameter of the bearing holder and a coil wound around the core; a rotor case having a magnet mounted therein so as to rotate by electromagnetic force with the armature and mounted on an outer diameter of the shaft; and an electromagnet selectively mounted on the armature or the bearing holder so as to face the rotor case, thereby preventing floating or separation of the rotor case by attractive force.

### CROSS REFERENCE TO RELATED APPLICATION

This application claims the benefit of Korean Patent Application No. 10-2011-0093601, filed on Sep. 16, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Recently, in accordance with miniaturization of electronic devices, capacity of a storage memory has correspondingly increased. Therefore, miniaturization and high speed rotation of a spindle motor used in a driving device for a large capacity memory storage device such as an optical disk, an optical disk drive (ODD), or a half-height driving set have been demanded.

When the spindle motor rotates at a high speed, stable rotation of a disk driven by the spindle motor is required, which requires stable rotation of a rotor. In order to solve this technical problem, various attempts have been conducted.

Meanwhile, recently, a cost of the spindle motor has rapidly increased due to a rapid increase in cost of a rare earth magnet. A bonded permanent magnet is required for driving the spindle motor, and a sintered permanent magnet is required for holding a rotor. Particularly, a cost of the sintered magnet has rapidly increased. Therefore, a motor having a more competitive price through a design substituting for the sintered magnet has been demanded.

In the spindle motor according to the prior art, an attractive magnet is mounted in order to prevent the rotor from being separated at the time of rotation of the spindle motor or allow a recording device to be stably rotated. However, the spindle motor according to the prior art uses the rare earth magnet, such that a cost thereof had rapidly increased.

### SUMMARY OF THE INVENTION

The present invention has been made in an effort to provide a spindle motor having a high competitive price.

According to a preferred embodiment of the present invention, there is provided a spindle motor including: a shaft; a bearing receiving the shaft therein to thereby rotatably support the shaft; a bearing holder having the bearing mounted therein; an armature including a core stacked on an outer diameter of the bearing holder and a coil wound around the core; a rotor case having a magnet mounted therein so as to rotate by electromagnetic force with the armature and mounted on an outer diameter of the shaft; and an electromagnet selectively mounted on the armature or the bearing holder so as to face the rotor case, thereby preventing floating or separation of the rotor case by attractive force.

The electromagnet may have a shape in which the coil is wound around the core.

The core of the electromagnet may be a ring type or a linear type.

The electromagnet may be mounted on one surface of the core mounted to face the magnet.

The spindle motor may further include a controlling unit controlling current or voltage applied to the electromagnet.

### BRIEF DESCRIPTION OF THE DRAWINGS

FIG. 1 is a partial cross-sectional view of a spindle motor according to a preferred embodiment of the present invention;

FIG. 2 is a partially exploded view of the spindle motor according to the preferred embodiment of the present invention;

FIG. 3 is a partially enlarged view of the spindle motor according to the preferred embodiment of the present invention; and

FIG. 4 is a flow chart showing an operation of an electromagnet of the spindle motor according to the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

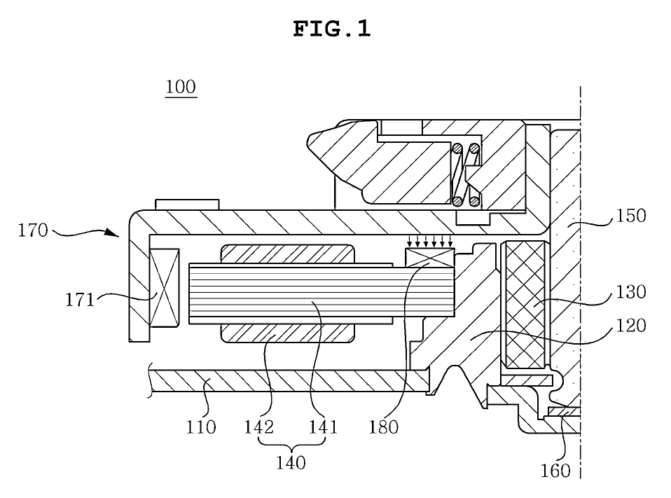

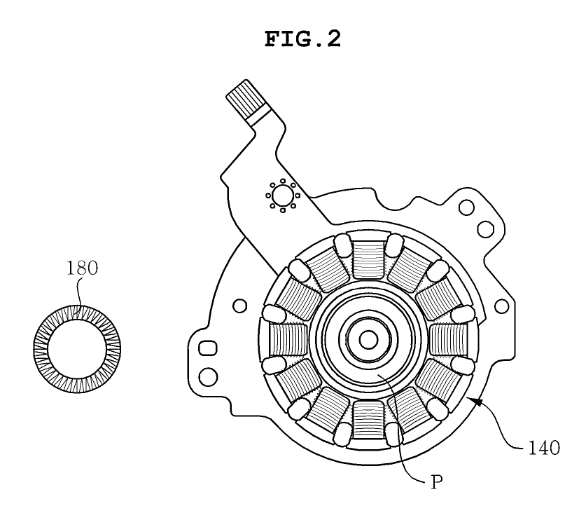

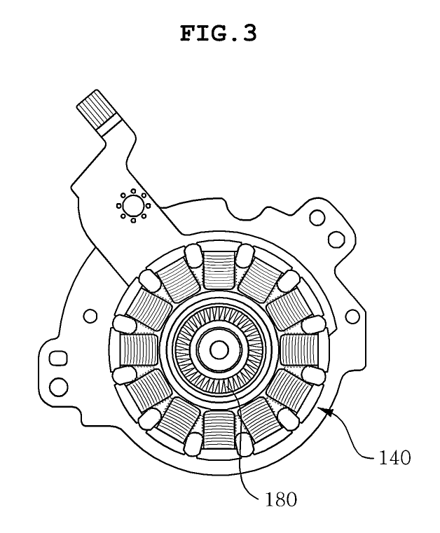

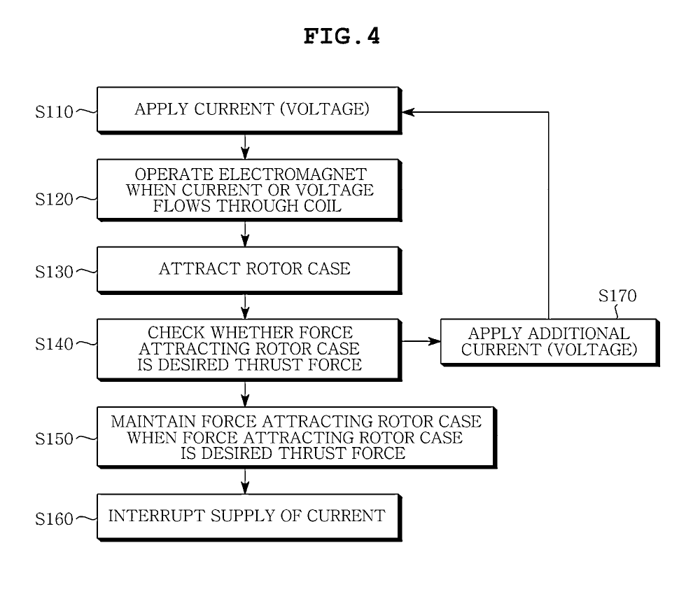

FIG. 1 is a partial cross-sectional view of a spindle motor 100 according to a preferred embodiment of the present invention: FIG. 2 is a partially exploded view of the spindle motor 100 according to the preferred embodiment of the present invention; and FIG. 3 is a partially enlarged view of the spindle motor 100 according to the preferred embodiment of the present invention. In addition, FIG. 4 is a flow chart showing an operation of an electromagnet of the spindle motor 100 according to the preferred embodiment of the present invention.

As shown in FIG. 1, the spindle motor 100 according to the preferred embodiment of the present invention includes a plate 110, a bearing holder 120, a bearing 130, an armature 140, a shaft 150, a thrust plate 160, a rotor case 170, and an electromagnet 180.

The plate 110, which is to fixedly support the entire spindle motor 100, is fixedly mounted in a device such as an optical disk drive, or the like, having the spindle motor 100 mounted therein. Here, the plate 110 is made of a light weight material such as an aluminum plate, an aluminum alloy plate, or the like. However, the plate 110 may also be made of a steel plate.

In addition, the plate 110 includes a coupling part (not shown) protruded therefrom, wherein the coupling part (not shown) includes the bearing holder 120 coupled thereto.

The coupling part (not shown) includes a connecting part and a fixing part so that the bearing holder 120 is coupled and fixed to an upper surface of the plate 110.

The bearing holder 120, which is to receive the bearing 130 therein, is fixedly coupled to the coupling part (not shown) of the plate 110.

The bearing holder 120 includes a cylindrical body part (not shown) closely adhered to an outer peripheral surface of the bearing 130 to thereby support the bearing 130 and a plate support part (not shown) formed to be stepped with respect to the body part (not shown) and support an upper portion of the plate 110.

The bearing 130, which is to rotatably support the shaft 150, has a generally hollow cylindrical shape and includes an inner diameter part (not shown) facing the shaft 150 and a lower surface (not shown) facing the thrust plate 160.

The armature 140, which is to form an electric field by receiving external power in order to rotate the rotor case 170 having an optical disk or a magnetic disk mounted thereon, is configured of a core 141 formed by stacking a plurality of sheets of thin metal plates and a coil 142 wound many times around the core 141.

The core 141 is fixedly mounted on an outer peripheral surface of the bearing holder 120 and the coil 142 is wound around the core 141. Here, the coil 142 forms an electric field by current applied from the outside thereto to thereby rotate the rotor case 170 by electromagnetic force formed between the coil 142 and a magnet 171 of the rotor case 170.

The shaft 150, which is to support the rotor case 170 in an axial direction, is inserted into the bearing 130 and is rotatably supported by the bearing 130.

Meanwhile, the shaft 150 includes the thrust plate 160 disposed on a lower portion thereof, wherein the thrust plate 160 is fixed to the plate 110 disposed under the bearing 130. Separate laser welding, or the like, may be performed in order to fix the thrust plate 160 to the plate 110. However, unlike this, the thrust plate 160 may be press-fitted and coupled into the trust plate 160 and the plate 110 by having a predetermined pressure applied thereto.

The rotor case 170, which is to have an optical disk or a magnetic disk (not shown) mounted thereon and rotate the optical disk or the magnetic disk, includes a disk part (not shown) having the shaft 150 fixedly mounted thereto and an annular edge part (not shown) extended from a distal end of the disk part (not shown).

The disk part (not shown) includes the shaft 150 fixedly and insertedly coupled to a central portion thereof, and the edge part (not shown) is extended in an axial direction of the shaft 150 so that an inner peripheral surface thereof faces the armature 140 and includes the magnet 171 fixedly mounted to the inner peripheral surface thereof, wherein the magnet 171 forms a magnetic field so as to generate electromagnetic force with the electric field formed in the coil 142.

The electromagnet 180, which is mounted on an upper portion of the core 141 so as to face a lower portion of the rotor case 170, is mounted in order to prevent the rotor case 170 from being separated at the time of rotation of the motor or allow a recording device to be stably rotated.

FIG. 2 is a partial exploded view of the spindle motor 100 according to the preferred embodiment of the present invention. Referring to FIG. 2, the electromagnet 180 is mounted in space P, which is a position on the armature 140.

The electromagnet 180, which is to substitute for an expensive sintered magnet (a permanent magnet), is formed by densely winding a coil around a ring type or linear type core.

The electromagnet 180 is mounted on the outer peripheral surface of the bearing holder 120 and on the upper portion of the core 141, has positive (+) and negative (−) poles allowing current to flow therethrough, and is connected to a circuit board. Here, the intensity of the current may be controlled, such that a desired attractive force may be controlled, and mechanical specifications are fixed and current specifications are specified, such that they may become public specifications in the future.

Therefore, in order to maintain the attractive force at the time of the rotation of the motor, the electromagnet 180 formed by densely winding the coil around the core is used instead of the expensive permanent magnet, thereby making it possible to significantly reduce a cost of the motor.

FIG. 3 shows the electromagnet 180 mounted in the spindle motor 100 according to the preferred embodiment of the present invention.

A position at which the electromagnet 180 is mounted is not limited. That is, the electromagnet 180 may be mounted at any position facing the lower portion of the rotor case 170 so as to prevent the separation of the rotor case 170 at the time of the rotation of the motor.

FIG. 4 is a flow chart of a controlling unit of the spindle motor 100 according to the preferred embodiment of the present invention.

As shown in FIG. 4, the spindle motor according to the preferred embodiment of the present invention further includes a controlling unit controlling current or voltage applied to the electromagnet. In the controlling unit, the current or the voltage is applied (S110), and the electromagnet operates (S120) when the current or the voltage is applied to the electromagnet through the coil. When the electromagnet operates, it attracts the rotor case (S130), whether force attracting the rotor case is a desired thrust force is checked (S140), the force attracting the rotor case is maintained when the force attracting the rotor case is a desired thrust force (S150), and the supply of the current is interrupted (S160). On the other hand, when the force attracting the rotor case is not a desired thrust force, additional current is applied to the electromagnet (S170).

As described above, in the case of the spindle motor 100 according to the preferred embodiment of the present invention, the electromagnet 180 is mounted on the upper portion of the core 141 so as to face the lower portion of the rotor case 170 in order to prevent the rotor case 170 from being separated at the time of rotation of the motor or allow the recording device to be stably rotated.

Therefore, the electromagnet 180 formed by densely winding the coil around the core is used instead of the expensive permanent magnet that has been used in the prior art, thereby making it possible to significantly reduce a cost of the motor.

With the spindle motor according to the preferred embodiment of the present invention, the electromagnet is mounted on the upper portion of the core so as to face the lower portion of the rotor case in order to prevent the rotor case from being separated at the time of rotation of the motor or allow the recording device to be stably rotated.

The electromagnet is mounted on the outer peripheral surface of the bearing holder and on the upper portion of the core, has positive (+) and negative (−) poles allowing current to flow therethrough, and is connected to a circuit board. Here, the intensity of the current may be controlled, such that a desired attractive force may be controlled, and mechanical specifications are fixed and current specifications are specified, such that they may become public specifications in the future.

Therefore, the spindle motor having the electromagnet mounted therein is provided, such that the electromagnet formed by densely winding the coil around the core is used instead of the expensive permanent magnet that has been used in the prior art, thereby making it possible to significantly reduce a cost of the motor.

Although the embodiment of the present invention has been disclosed for illustrative purposes, it will be appreciated that a spindle motor according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft;
a bearing receiving the shaft therein to thereby rotatably support the shaft;
a bearing holder having the bearing mounted therein;
an armature including a core stacked on an outer diameter of the bearing holder and a coil wound around the core;
a rotor case having a magnet mounted therein so as to rotate by electromagnetic force with the armature and mounted on an outer diameter of the shaft; and
an electromagnet selectively mounted on the armature or the bearing holder so as to face the rotor case, thereby preventing floating or separation of the rotor case by attractive force.

2. The spindle motor as set forth in claim 1, wherein the electromagnet has a shape in which the coil is wound around the core.

3. The spindle motor as set forth in claim 1, wherein the core of the electromagnet is a ring type or a linear type.

4. The spindle motor as set forth in claim 1, wherein the electromagnet is mounted on one surface of the core mounted to face the magnet.

5. The spindle motor as set forth in claim 1, further comprising a controlling unit controlling current or voltage applied to the electromagnet.
